(19) United States
(12) Patent Application Publication
(10) Pub. No.: US 2020/0200206 A1
(43) Pub. Date: Jun. 25, 2020

(54) PLUG BOLT

(71) Applicant: UNIVERSITY OF JOHANNESBURG, Johannesburg (ZA)

(72) Inventors: Devon John Coetzer, Johannesburg (ZA); Andre Leon Nel, Johannesburg (ZA)

(21) Appl. No.: 16/637,945

(22) PCT Filed: Aug. 8, 2018
(86) PCT No.: PCT/IB2018/055975

§ 371 Date: Feb. 10, 2020

(30) Foreign Application Priority Data
Aug. 11, 2017 (ZA) 2017/05444

(51) Int. Cl. F16B 31/02; F16B 23/00

(52) U.S. Cl. CPC F16B 31/021; F16B 23/0038; F16B 23/003

(57) ABSTRACT

This invention relates to a plug bolt (1) and more specifically, but not exclusively, to a plug bolt (1) for use with a device such as an air-cooled heat exchanger. One of the problems with conventional plug bolts is that when the bolts are over tightened, it may damage the thread of the device it is installed in. Once the thread is damaged it has to be repaired, causing downtime, or where it is not possible to repair, the device will have to be replaced. It is accordingly an object of this invention to provide a plug bolt (1) which, at least partially, alleviates some of the problems associated with the prior art. It is envisaged that the invention will provide a plug bolt (1) which fails before it is overtightened to prevent damage, is easy to manufacture, and is as simple to use as the prior art.

### FIELD OF THE INVENTION

This invention relates to plug bolt and more specifically, but not exclusively, to a plug bolt for use with an air-cooled heat exchanger.

### BACKGROUND TO THE INVENTION

Plug bolts (or inspection bolts) are known in the art. Plug bolts may provide access to the interiors of sumps, pressure vessels, or other parts of machines or plants for inspection or maintenance purposes. Plug bolts typically cost orders of magnitude less than the devices they are installed in.

An example where plug bolts are used is air-cooled heat exchangers where the bolts are used to provide access to the interior of tubes used in the heat exchanger. Specifically, a plurality of bolts are used to seal a plug sheet which is connected to a tube sheet. Regular cleaning and inspection of the tubes of the heat exchanger is crucial to maintain performance and prolong the lifespan of the device.

One of the problems with conventional plug bolts is that when the bolts are over tightened, it may damage the thread of the device it is installed in. Once the thread is damaged it has to be repaired, causing downtime, or where it is not possible to repair, the device will have to be replaced.

This is a common problem in air-cooled heat exchangers where a damaged thread on the heat exchanger may lead to downtime of an entire plant. Such downtime may be very costly. In cases where only the bolt threads are stripped, the bolt can be replaced. However, in instances where the heat exchanger's threads are damaged, repairs must be done on the device or, if repair is not possible, the device must be replaced.

### OBJECT OF THE INVENTION

It is accordingly an object of this invention to provide a plug bolt which, at least partially, alleviates some of the problems associated with the prior art.

### SUMMARY OF THE INVENTION

In accordance with the invention there is provided a plug bolt comprising:
a body with a primary head at one end of the body and a threaded end at the opposite end of the body;
a secondary head in between the primary head and the threaded end; and
a weakened portion between the primary and secondary head;
the weakened portion being shaped and sized such that the weakened portion fails when torque applied to the primary head exceeds a predetermined threshold.

The weakened portion may be a shearing portion wherein the primary head shears from the bolt when the torque exceeds the threshold.

The heads may be adapted or shaped and sized to engage a tool used to fasten the plug bolt.

The predetermined threshold may be such that the primary head will shear from the bolt before the thread is damaged.

The primary head may be shaped and sized to prevent access to the secondary head with a tool.

The primary head may be relatively larger than the secondary head to prevent a tool being used on the secondary head.

The size of the primary head may be equal to the circumscribed diameter of the secondary head to prevent contact with the secondary head whilst the primary head is intact.

The secondary head may be encapsulated by a casing to prevent a tool being used on the secondary head.

The casing may be removed once the primary head has sheared to provide access to the secondary head.

The casing may be manufactured from polytetrafluoroethylene.

The primary and secondary heads may be hexagonal bolt heads. The secondary head may have a stellated shape.

Failure of the weakened portion provides visual indication of over tightening of the plug bolt.

The stellated head is shaped and sized such that the portions thereof will deform when the torque applied thereto is higher than a predetermined threshold. The threshold is such that the head deforms before the thread is damaged.

The deformation of the stellated head provides a visual indication of over tightening of the plug bolt.

The predetermined threshold may be between 250 and 550 Nm torque.

The bolt may be manufactured from carbon steel, such as:
SA-105/SA-105M; or
SA-106/SA-106M.

### BRIEF DESCRIPTION OF THE DRAWINGS

Embodiments of the invention are described below, by way of example only, and with reference to the drawings in which:

FIG. 1 is a schematic perspective view of a plug bolt;

FIG. 2 is a schematic side view of the plug bolt of FIG. 1;

FIG. 3 is a schematic side view of a second embodiment of a plug bolt;

FIG. 4 is a schematic perspective of a third embodiment of a plug bolt;

FIG. 5 is a schematic side view of the plug bolt of FIG. 4;

FIG. 6 is a schematic perspective view of the third embodiment of the plug bolt wherein the primary head is sheared off and the secondary head is engaged by a ring spanner; and

FIG. 7 is a schematic top view of the plug bolt of FIG. 6.

### DETAILED DESCRIPTION OF THE DRAWINGS

With reference to the drawings in which like features are indicated by like numerals, a plug bolt is generally indicated by reference numeral 1.

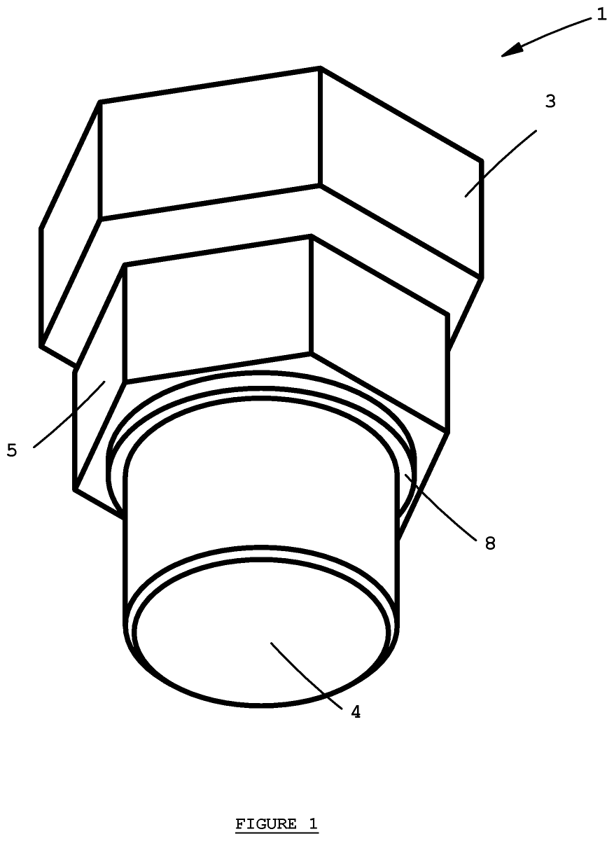

The plug bolt 1 includes a body with a primary head 3 at one end of the bolt 1 and a threaded portion 4 at the opposite end of the bolt 1. The threaded portion 4 engages complementary thread in a device (not shown) and the primary head 3 is used to tighten the bolt 1. In the example shown in FIGS. 1 to 3, the primary head 3 is in the form of a hexagonal bolt head such that the bolt 1 may be tightened using standard tools. The bolt 1 is generally elongated and the threaded portion is cylindrical. The bolt is typically manufactured from carbon steel, such as SA-105/SA-105M, or SA-106/SA-106M.

The bolt includes a secondary head 5 between the primary head 3 and the threaded portion 4. In the example shown in FIGS. 1 to 3 the secondary head 5 is in the form of a hexagonal bolt head. In another embodiment, the secondary head may have a stellated shape which provides additional features described further below.

The bolt 1 includes a shoulder 8 between the secondary head 5 and the threaded portion 4. The outer diameter of the shoulder 8 is smaller than that of the secondary head 5 and larger than the threaded portion 4. The shoulder 8 enables better seating of a washer used with the bolt 1.

The bolt 1 has a weakened portion 6 between the primary head 3 and the secondary head 5. The weakened portion 6 is in the form of an undercut, which is machined to be relatively smaller than the diameter of the threaded portion of the bolt 1. The undercut is a groove which is machined on a lathe using a parting tool to decrease the diameter of the weakened portion 6. The weakened portion 6 connects the primary hexagonal head 3 with the secondary head 5 and is shaped and sized such that the primary head 3 will shear from the secondary head 5 when the torque applied to the primary hexagonal head 3 exceeds a predetermined threshold. The weakened portion 6 will fail where the area (or diameter) of the portion is smallest. It is thus possible to calculate the torque required to shear the weakened portion 6 at the weakest point and machine the minimum diameter such that the weakened portion 6 will fail before the predetermined threshold is reached.

The predetermined threshold, and consequently the size and shape of the weakened portion 6, is chosen such that the weakened portion will fail before the thread 4 is damaged. Furthermore, the weakened portion 6 may also be designed such that the complementary thread on the device, which is typically more expensive and more expensive to repair than the bolt, is not damaged before failure of the weakened portion. Where the weakened portion fails, the primary head 3 will either completely shear from the bolt or deform to such an extent that it will be visible. This provides a form of visual indication where the bolt has been over tightened. The predetermined threshold may be between 250 and 550 Nm.

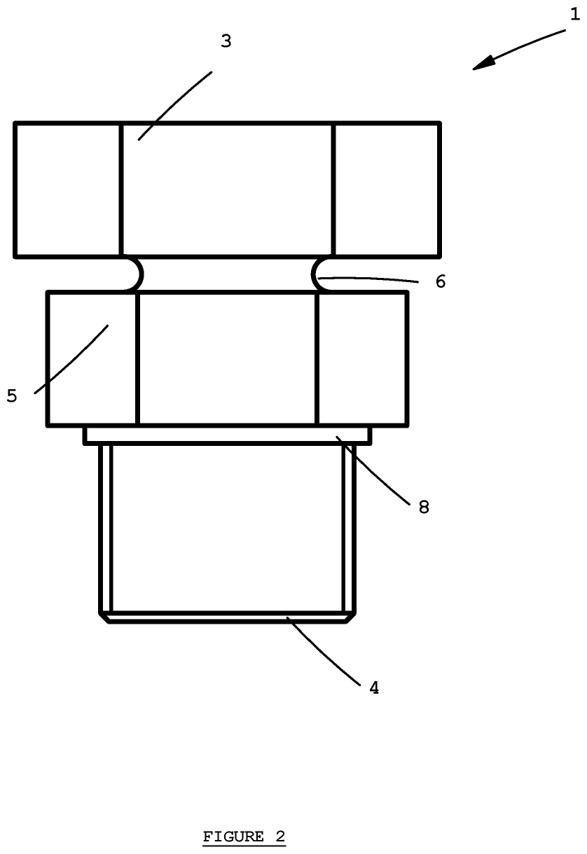

The primary head 3 is shaped and sized to prevent physical access to the secondary head 5 with a tool. In a first example (shown in FIGS. 1 and 2), the primary head 3 is relatively larger than the secondary head 5 to prevent a tool being used on the secondary head. Specifically, the size of the primary head 3 is greater than or equal to the circumscribed diameter of the secondary head 5. This prevents accidental engagement of the secondary head by the tool used for the primary head whilst the primary head is intact. Further, any tool large enough to engage the primary head 3, will be too large to even partially engage the secondary head 5.

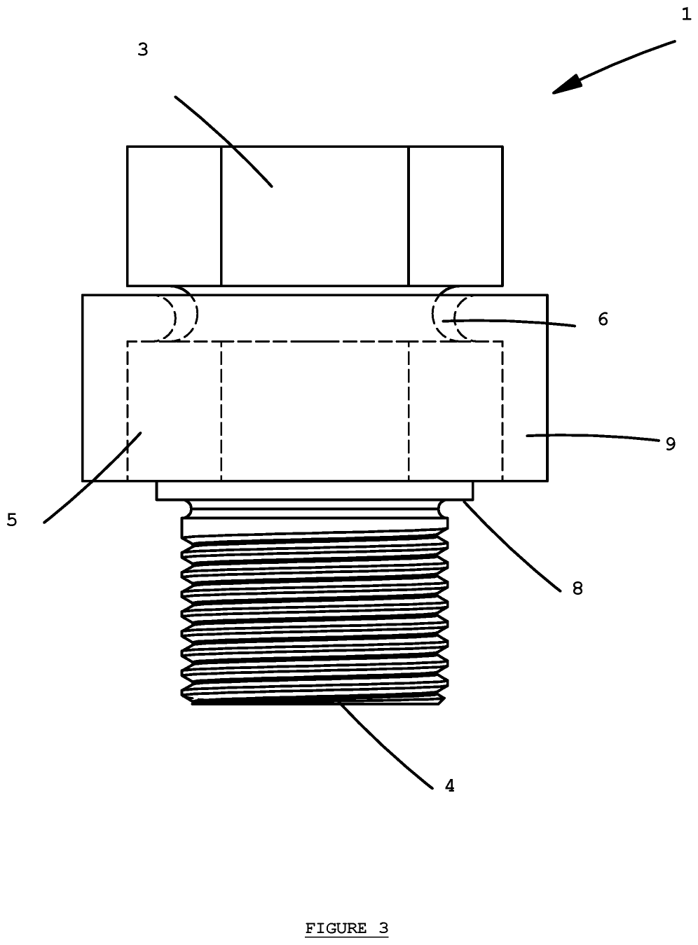

In another example (shown in FIG. 3), the access to the secondary head 5 is prevented by encapsulating the secondary head in a casing 9 to prevent a tool from being used thereon. The casing may be manufactured from polytetrafluoroethylene.

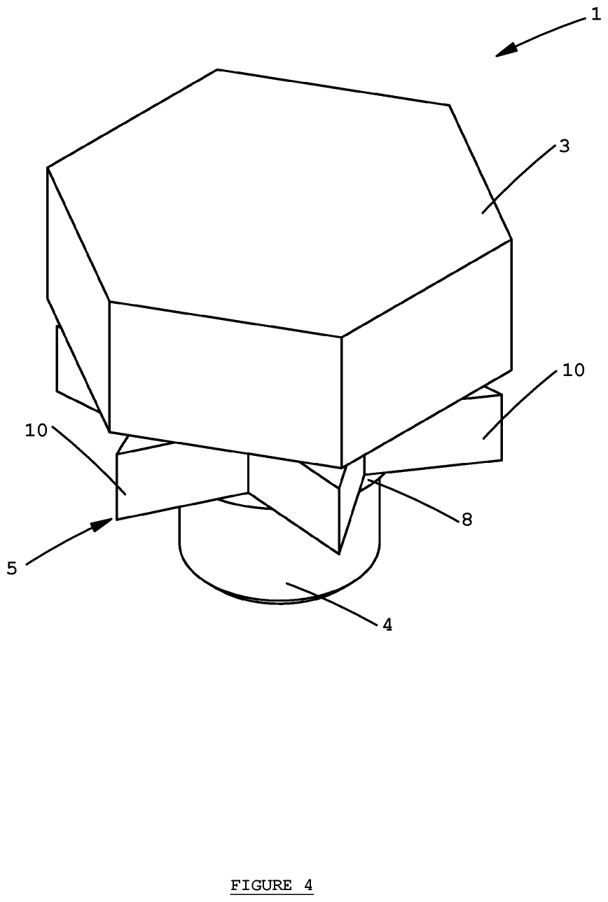

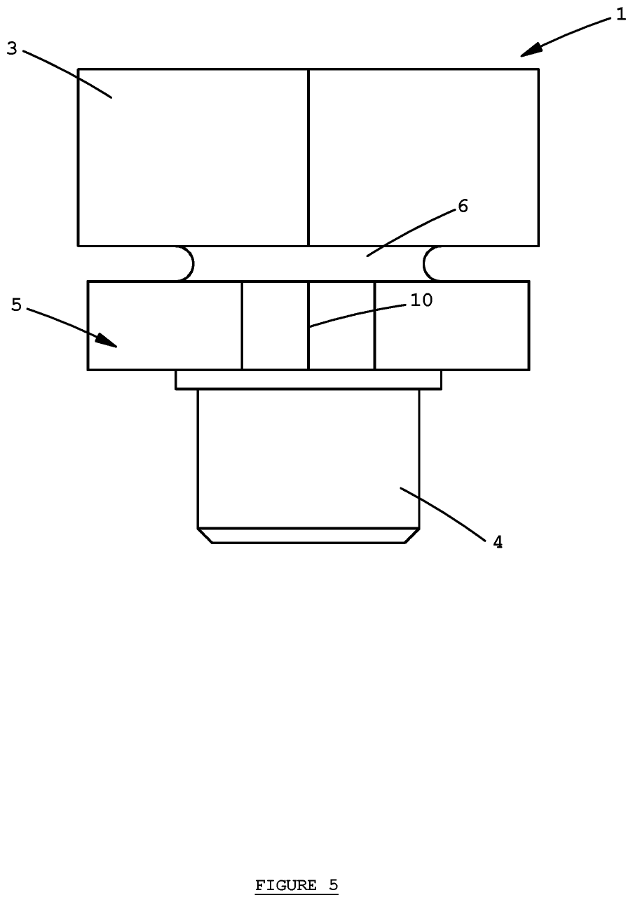

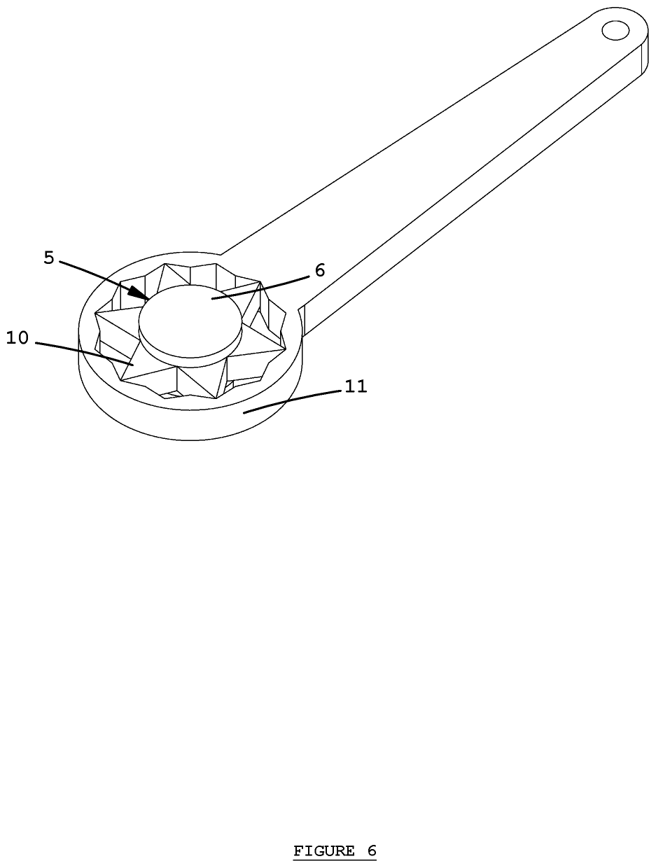

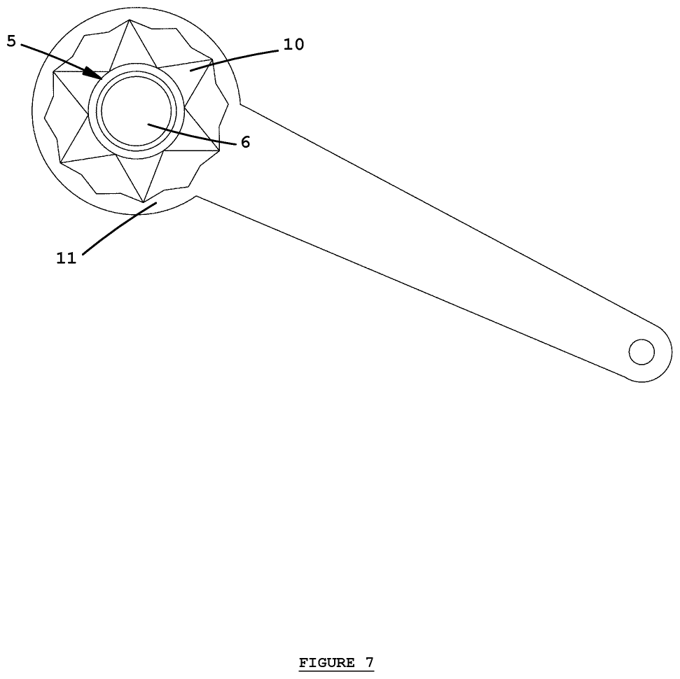

In the embodiment wherein the secondary head 5 has a stellated shape (shown in FIGS. 4 to 7), the head is shaped and sized such that portions of the head will deform when the torque applied to the stellated head 5 is higher than a predetermined threshold. A stellated head will typically be star shaped with protrusions 10 extending radially outward from the central axis of the bolt. In the absence of a special tool, a stellated head may be engaged by a ring spanner 11, which engages the ends of the protrusions 10. The protrusions 10 may be shaped and sized to deform when the torque applied by the spanner 11 exceeds a threshold. This provides additional protection to prevent damage to the thread and the device when the secondary head is engaged. The deformation of the protrusions 10 will also prevent the tool from engaging the damaged head 5 and causing further damage. The stellated head prevents a user from using a tool which is not restricted by the relative size of the larger primary head 3, such as a flat or shifting spanner, from being used on the secondary head 5 directly. Where such a tool is used, protrusions 11 of the stellated head will fail before the thread would be damaged. Further, the deformation of the stellated head 5 provides a visual indication of over tightening of the plug bolt 1.

In use, many bolts 1 may be installed on a single device. Typically, during inspection or maintenance, the bolts 1 will be removed, the device inspected, cleaned or maintained, and sacrificial washers may be replaced. The bolts are then replaced in the device. A prudent approach would be to use a torque-wrench to fasten the bolts. However, it is possible that the torque wrench may not be properly calibrated or that it may be adjusted to an incorrect torque setting. This may cause a user to over tighten the bolts. A less prudent approach would be to use a tool like a slogging spanner (typically in conjunction with a heavy hammer). With such an approach, it will be very possible to over-tighten one or more of the bolts.

If during the replacement of the bolts one or more of the bolts 1 are over tightened, the weakened portion 6 of the bolt 1 will fail and prevent damage to the thread of the device. A user or supervisor overseeing the process will find on a visual inspection of the bolts that a head is askew or missing which indicates attempted over-tightening. The over-tightened bolt may be replaced quickly, and before the device is used. Where the primary head has completely sheared from the bolt 1, the secondary head may be used to loosen the bolt.

It is envisaged that the invention will provide a plug bolt which fails before it is overtightened to prevent damage to a device it is installed in, is easy to manufacture, and is as simple to use as the prior art.

The invention is not limited to the precise details as described herein. For example, instead of hexagonal or stellated head a square or external wrenching bolt head may be employed. Further, the weakened portion need not be weakened by a machined groove, and holes or other weakening structures may be employed to achieve the same result.

1. A plug bolt comprising:
a body with a primary head at one end of the body and a threaded portion at an opposite end of the body;
a secondary head between the primary head and the threaded portion; and
a weakened portion between the primary and secondary head;
the weakened portion being shaped and sized such that the weakened portion fails when torque applied to the primary head exceeds a predetermined threshold.

2. The plug bolt of claim 1 wherein the weakened portion is a shearing portion and the primary head shears from the bolt when the applied torque exceeds the threshold.

3. The plug bolt of claim 1 or 2 wherein the heads are shaped and sized to engage a tool used to fasten the plug bolt.

4. The plug bolt of claims 1 to 3 wherein the predetermined threshold is such that the primary head will shear from the bolt before the thread is damaged.

5. The plug bolt of claims 1 to 4 wherein failure of the weakened portion provides visual indication of over tightening of the plug bolt.

6. The plug bolt of claims 1 to 5 wherein the primary head is shaped and sized to prevent access to the secondary head with a tool.

7. The plug bolt of claims 1 to 6 wherein the primary head is relatively larger than the secondary head to prevent a tool being used on the secondary head.

8. The plug bolt of claims 1 to 7 wherein the size of the primary head is larger than the circumscribed diameter of the secondary head to prevent engagement of the secondary head whilst the primary head is intact.

9. The plug bolt of claims 1 to 8 wherein the secondary head is encapsulated by a casing to prevent a tool being used on the secondary head.

10. The plug bolt of claim 9 wherein the casing is removable once the primary head has sheared to provide access to the secondary head.

11. The plug bolt of claim 9 or 10 wherein the casing is manufactured from polytetrafluoroethylene.

12. The plug bolt of claims 1 to 11 wherein the secondary head deforms before the predetermined threshold is reached.

13. The plug bolt of claims 1 to 12 wherein the primary and secondary heads are hexagonal bolt heads.

14. The plug bolt of claims 1 to 12 wherein the secondary head has a stellated shape.

15. The plug bolt of claim 14 wherein the stellated shape includes radial protrusions which are shaped and sized to fail when torque applied to the head exceeds the predetermined threshold.

16. The plug bolt of claim 15 wherein the stellated head is shaped and sized such that the protrusions will deform when the torque applied thereto is higher than the predetermined threshold.

17. The plug bolt of claims 14 to 16 wherein deformation of the stellated head provides a visual indication of over tightening of the plug bolt.

18. The plug bolt of claims 1 to 17 wherein the predetermined threshold is between 250 and 550 Nm torque.

19. The plug bolt of claims 1 to 18 wherein the plug bolt is manufactured from SA-105/SA-105M carbon steel.

20. The plug bolt of claims 1 to 18 wherein the plug bolt is manufactured from SA-106/SA-106M carbon steel.

21. The plug bolt of claims 1 to 20, substantially as herein described and illustrated.

22. A plug bolt, substantially as herein described and illustrated.

23. A plug bolt, substantially as shown in FIGS. 1 to 7.
